(19) United States
(12) Patent Application Publication
(10) Pub. No.: US 2010/0071569 A1
(43) Pub. Date: Mar. 25, 2010

(54) AVOCADO PULPER

(76) Inventor: Richard E. MOORE, Chula Vista, CA (US)

Correspondence Address: FRANK G MORKUNAS, 7750 DAGGET ST, SUITE 203, SAN DIEGO, CA, 92111, US

(21) Appl. No.: 12/628,806

(22) Filed: Dec. 1, 2009

Related U.S. Application Data
(63) Continuation-in-part of application No. 12/423,356, filed on Apr. 14, 2009.
Application No. 12/423,356 is a continuation-in-part of application No. 11/845,184, filed on Aug. 27, 2007, now Pat. No. 7,658,144.
Application No. 11/845,184 is a continuation-in-part of application No. 11/280,068, filed on Nov. 16, 2005, now Pat. No. 7,444,930.

(51) Int. Cl. A23N 4/12; A23N 7/10

(52) U.S. Cl. 99/547; 99/587

(57) ABSTRACT

An avocado pulper having two grip belts approximately oval in shape and further having a plurality of grip plates around the grip belts. The grip plates are knurled thereby facilitating a grasping of an avocado as it is conveyed into the grip belts and rides through to the rear opening. A pivotable and adjustable belt guide within an inner section of each grip belt is adapted to exert maximum squeezing pressure on the avocado at the approximate middle section of the grip belts at which point the grip belts are in approximate contact with one another. Pulp is thereby squeezed from the avocado. The grip belts separate at the approximate rear defining for releasing the skin of the avocado. A de-seeder adjacent to the front end opening of the grip belts removes the seed from the avocado prior to its entry into the maximum squeezing section.

### CROSS REFERENCES TO RELATED APPLICATIONS

This application is a continuation-in-part of nonprovisional application, application Ser. No. 12/423,356, filed on Apr. 14, 2009; which is a continuation-in-part of nonprovisional application, application Ser. No. 11/845,184, filed on Aug. 27, 2007.

### STATEMENT REGARDING FEDERALLY-SPONSORED RESEARCH OR DEVELOPMENT

Not applicable.

### BACKGROUND

This avocado pulper of this disclosure relates to an improvement in pulping and de-seeding machines, and more particularly to machines for removing skin, pulp, and seed from an avocado.

Avocados have become more and more popular for their versatility and arguable health-related benefits. They come in various varieties and sizes. For example, West Indian avocados produce enormous, smooth round, glossy green fruits that are low in oil and can weigh up to two pounds. Guatemalan types produce medium ovoid or pear-shaped, pebbled green fruits that turn blackish-green when ripe. The fruit or pulp of Mexican varieties are smaller (six to ten ounces) with skins that turn glossy green or black when ripe.

Regardless the pulp of avocados is deep green near the skin, becoming yellowish nearer the single large, inedible ovoid seed. The pulp is hard when harvested but softens to a buttery texture. Avocados are high in monosaturates and the oil content is second only to olives among fruits. Clinical feeding studies in humans have shown that avocado oil can reduce blood cholesterol.

In many cases, fruits (such as avocados) and vegetables are more easily de-skinned by the heating of these foods. Such heating does not adversely affect the flavor, texture, or appearance of most such foods. Processing avocados by first heating for the purpose of de-skinning them, however, is not nutritionally sound. Avocados are a fruit which is extremely sensitive to heat. This is particularly so in its green (chlorophyll) layer of its pulp as it lies immediately below the skin and, consequently, is subject to greatest heat exposure and nutritional loss and flavor loss. Additionally, avocado skins are particularly thick and/or rough and most processing techniques are manual or if mechanized, the apparatus is expensive, complex, and not as efficient as desired in that usable pulp is lost in the process.

Because of their popularity and growing popularity, and commercialization of avocados, a need existed to effectively and efficiently remove the pulp from an avocado for processing regardless of the size or type of avocado being processed. The prior art has numerous de-skinning or peeling machines and pulp or fruit removal machines which have been cited in this application. Most are extremely complex, somewhat cumbersome, and costly to manufacture and maintain.

I have solved most of the problems associated with pulp removal and skin/seed disposal in my recently issued patent, U.S. Pat. No. 7,444,930, which issued on Nov. 4, 2008, and have enhanced upon such with my co-pending nonprovisional applications, application Ser. No. 11/845,184 filed on Aug. 27, 2007, application Ser. No. 11/845,233 filed on Aug. 27, 2007, and application Ser. No. 12/423,356 filed on Apr. 14, 2009; all of which are hereby incorporated by reference.

This current avocado pulper, however, is an even more vast improvement to all prior-art devices. It will de-seed, de-pulp, and de-skin an avocado with little human intervention; and, in the same amount of time, will produce more pulp than with any prior-art device and less waste of usable product will result. Unwanted items [skin and seed] will not be co-mingled with the pulp. Moreover, with the relative “flexibility” if the grip belts and the de-seeder, a hard avocado pulp or a stray seed will not jam the avocado pulper. All these advances and at a speed of production unsurpassed by any other device.

The foregoing has outlined some of the more pertinent objects of the avocado pulper of this disclosure. These objects should be construed to be merely illustrative of some of the more prominent features and applications of the avocado pulper of this disclosure. Many other beneficial results can be attained by applying the disclosed avocado pulper of this disclosure in a different manner or by modifying the avocado pulper of this disclosure within the scope of the disclosure. Accordingly, other objects and a fuller understanding of the avocado pulper of this disclosure may be had by referring to the summary of the avocado pulper of this disclosure and the detailed description of the preferred embodiment in addition to the scope of the avocado pulper of this disclosure defined by the claims taken in conjunction with the accompanying drawings.

### SUMMARY

The above-noted problems, among others, are overcome by the avocado pulper of this disclosure. Briefly stated, the avocado pulper of this disclosure contemplates two grip belts approximately oval in shape with each grip belt being chain-driven and having a plurality of knurled grip plates therearound. The grip plates grasp an avocado as it is conveyed into the front end opening of the grip belts and rides through the grip belts to the rear opening. A pivotable and adjustable belt guide within an inner section of each grip belt is adapted to exert maximum squeezing pressure on the avocado at the approximate middle section of the grip belts at which point the grip belts are in approximate contact with one another. Pulp is squeezed from the avocado and retrieved. The grip belts separate at the approximate rear defining a rear opening for releasing the skin of the avocado for disposal. A de-seeder adjacent to the front end opening of the grip belts removes the seed from the avocado prior to its entry into the maximum squeezing section.

The foregoing has outlined the more pertinent and important features of the avocado pulper of this disclosure in order that the detailed description that follows may be better understood so the present contributions to the art may be more fully appreciated. Additional features of the avocado pulper of this disclosure will be described hereinafter which form the subject of the claims. It should be appreciated by those skilled in the art that the conception and the disclosed specific embodiment may be readily utilized as a basis for modifying or designing other structures and methods for carrying out the same purposes of the avocado pulper of this disclosure. It also should be realized by those skilled in the art that such equivalent constructions and methods do not depart from the spirit and scope of the avocado pulper of this disclosure as set forth in the appended claims.

### BRIEF DESCRIPTION OF THE DRAWINGS

For a fuller understanding of the nature and objects of the avocado pulper of this disclosure, reference should be had to the following detailed description taken in conjunction with the accompanying drawings in which:

FIG. 1 is a perspective view of the avocado pulper.

FIG. 2 is a detailed cross-section view of the conveyer belt structure of the avocado pulper.

FIG. 3A, as taken on line 3-3 of FIG. 2, is a side elevation view, in partial cross-section, of the avocado pulper.

FIG. 3B is a detailed cut-away side view of the adjustment structure of the avocado pulper.

FIG. 4 is a detailed top plan view of the rear of the grip belt in cooperation with the avocado skin-scraping member.

FIG. 5 is a detailed cut-away side perspective view of the adjustment structure and the belt guide of the avocado pulper.

FIG. 6 is a perspective view of the two-piece belt guide of the avocado pulper.

FIG. 7A is a break-away view of the two-piece belt guide of the avocado pulper as shown in FIG. 6.

FIG. 7B is a detailed view of the connection aperture in the rear section guide of the belt guide of the avocado pulper as taken on reference character 7B of FIG. 7A.

FIG. 8 is a front elevation view of a grip plate of the grip belt of the avocado pulper.

FIG. 9 is a side elevation view of a grip plate of the grip belt of the avocado pulper.

FIG. 10, as taken on line 10-10 of FIG. 8, is a detailed view of the radial slot of the grip plate.

FIG. 11 is a detailed plan view of the peaks and grooves of a grip plates of the avocado pulper.

FIGS. 12, 13 and 13A are detailed cross-section views of the peaks and grooves of the grip plates of the avocado pulper.

FIG. 14, as taken on line 14-14 of FIG. 3A is a detailed view of the seed-cleaning structure of the avocado pulper.

### DETAILED DESCRIPTION

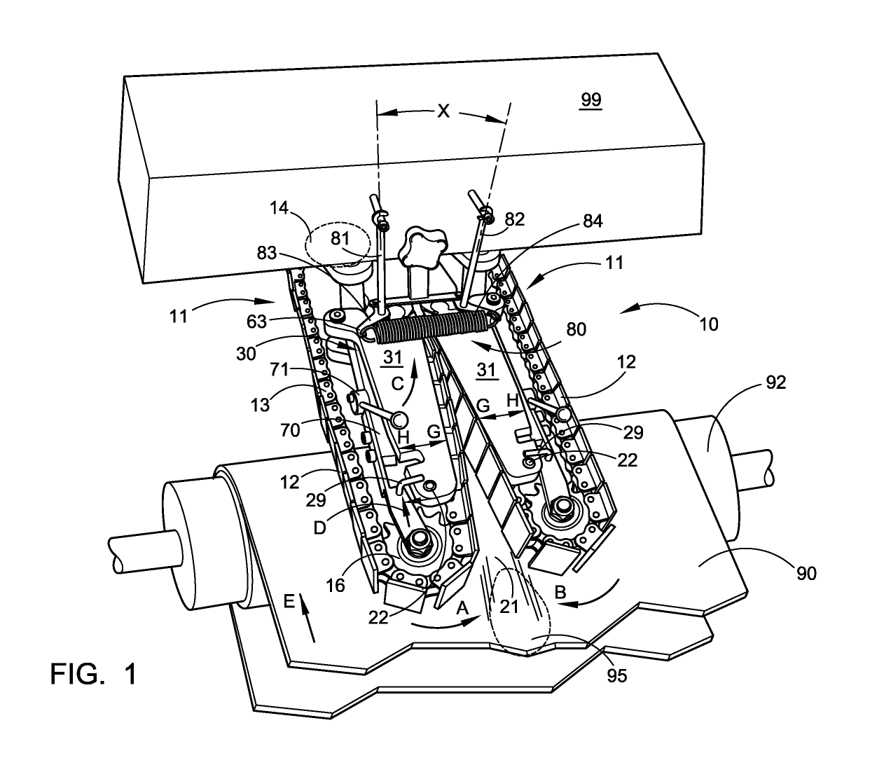

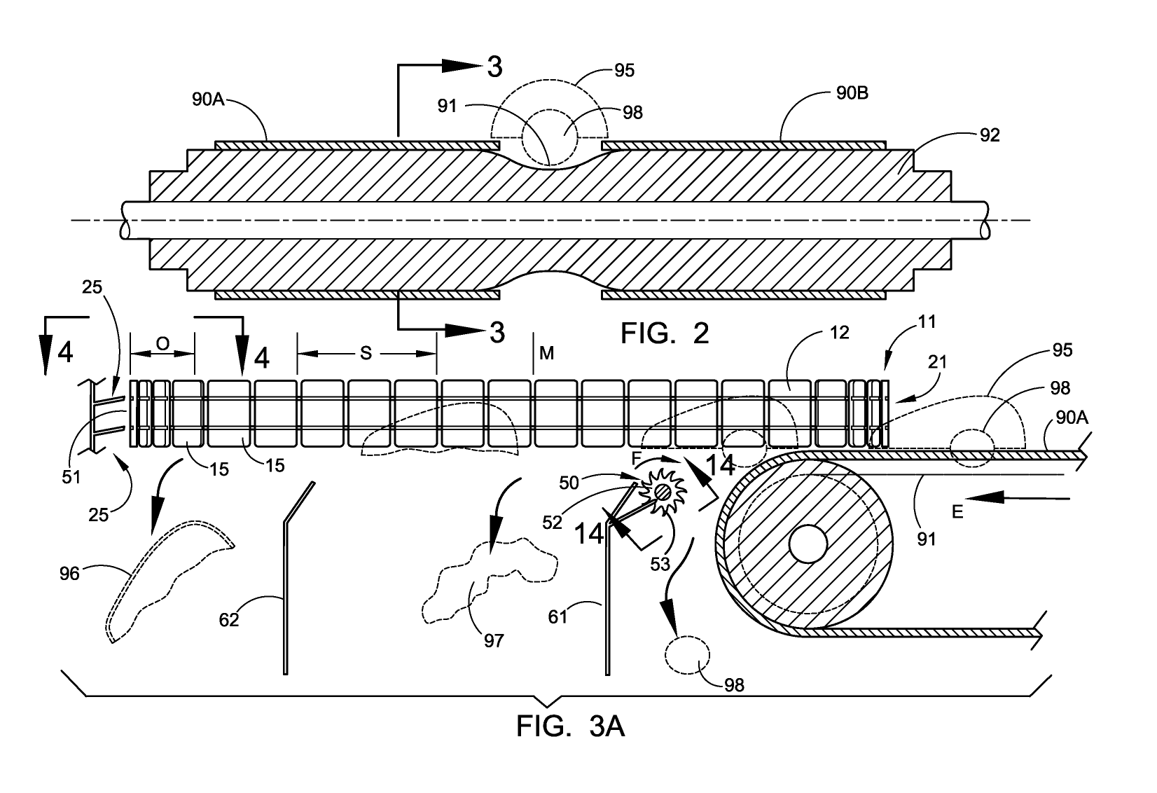

Referring now to the drawings in detail and in particular to FIG. 1, reference character 10 generally designates an avocado pulper constructed in accordance with a preferred embodiment of the avocado pulper of this disclosure. A conventional housing 99 is illustrated here which supports the structural components of the avocado pulper 10 as well as a conventional motor [not illustrated] for driving the grip belts 11. FIGS. 2, 3A, 3B, 4, and 5 illustrate the details of the conveyor 90, 90A, 90B, roller 92, and adjustment structure for the grip belts 11 and belt guides 30.

An avocado 95 will ride on a conveyor belt 90 toward an opening 21 at the front of and between two opposing grip belts 11, a first and a second grip belt rotating respectively in the direction of Arrow-A and Arrow-B. The opening 21 is sized to accommodate and fully receive an avocado therethrough. Each grip belt 11 also has a plurality of grip plates 12 therearound and is chain driven having the chain drive 13 at the rear of the grip plates 12 and holding the grip plates 12 thereto. A drive gear 14 attached to a conventional motor [not shown] and to the chain drive 13 causes the movement of each grip belt 11 in their respective directions of rotation. The fronts of the grip belts 11 are attached to an idler gear or spindle 16.

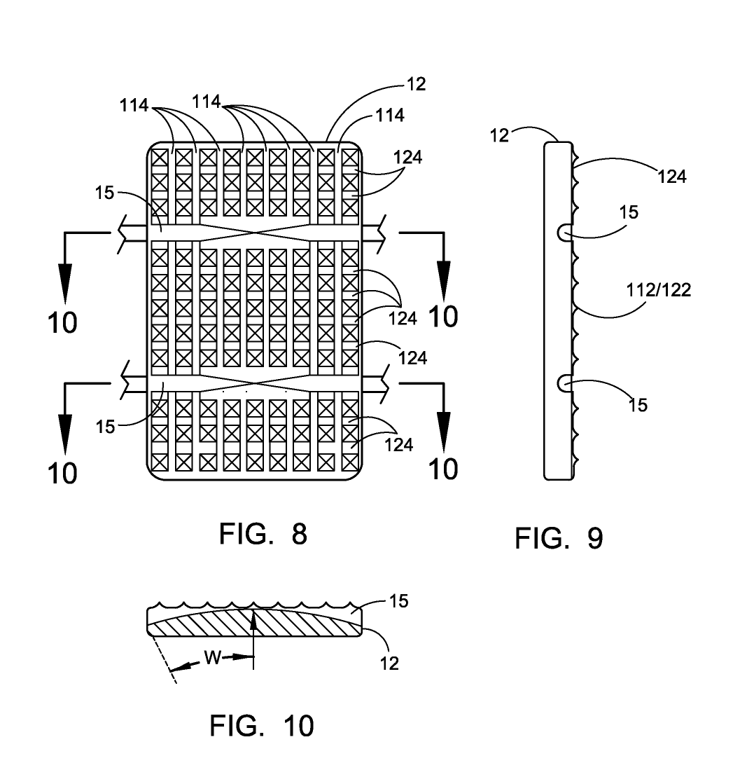

Each grip plate 12 is knurled for better grasping of the avocado 95 as it is driven and rides through the avocado pulper 10 [see FIGS. 8 and 9]. Each grip belt is approximately oval is shape and thereby each has an inner section in which there is a support plate 70 secured to the avocado pulper 10 for housing a pivotable belt guide 30.

There are belt guides 30, one set in each of the inner sections of the grip belts 11. The belt guides 30 are biased inward [by reference character 80], toward each other causing the grip belts 11 to come into near contact with each other at about their respective middles and rearward therefrom [i.e., adjusted to be as close together without the peaks 112, 122 actually coming into contact]. This structure causes the pulp 97 of the avocado 95 to be virtually fully squeezed from its skin 96 and be suitably captured for productive use and for the seed 98 and the skin 96 to be suitably disposed as later to be described.

The belt guide 30 is a two-piece structure having a front guide section 31 and a rear guide section 41 pivotably but removably attached to each other as best illustrated in FIGS. 6, 7A, and 7B. This component and its pivotability and biasing inward, along with the grip belt 10 structure, are important features to the overall functionality and versatility of the avocado pulper 10.

The front guide section 31 has a receiving aperture 37 at its front end and a retaining slot or cut-out 39 adjacent to and rearward from the receiving aperture 37. There is a rounded head extension 32 at its rear which has an aperture 33 therein. An adjusting tab 36 projects from the side of the front guide section 31 at its rear. A rear retaining aperture 34 courses through the adjusting tab 36. Also at the rear of the front guide section 31 is an elongated slot 38 through which a rod 81, 82 inserts, the purpose of which to be more fully explained later.

The rear guide section 41 has a receiving slot 47 at its rear and a connection aperture 42 at its front. The connection aperture 42 is sized to receive and retain the rounded head extension 32. An index pin 43 projects outward from the connection aperture 42. The belt guide 30 is a two-piece structure comprising the front guide section 31 and the rear guide section 41 connected to each other in pivotably fashion. The configuration of each guide section [front 31 and rear 41] causes this to occur.

Given the sizing of the connection aperture 42 with regard to the rounded head extension 32 permits a snapping of the two guide sections together. The index pin 43 mates with the aperture 33 of the rounded head extension 32 and facilitates pivoting movement in the direction of Arrow-G and Arrow-H and stabilizes the two guide sections 31, 41 and prevents them from upward or downward separation as the avocado pulper 10 is in operation. It should be understood that the index pin 43 may be on the rounded head section 32 and the mating aperture 33 may be in the connection aperture 42.

FIG. 7B illustrates in detail the opening of the connection aperture 42. Reference character Y represents the concave arc of connection aperture 42 and bears an angle ranging from approximately 185° to approximately 210°. Reference character Z represents the opening arc of connection aperture 42 and bears an angle ranging from approximately 150° to approximately 175°.

As mentioned above, each grip plate 12 is knurled. Any roughening of the surfaces will suffice but a more structured approach realizes better results. FIGS. 8 and 9 illustrate such better structure. A plurality of grooves 114 are cut vertically through each grip plate 12 [as illustrated and referred to herein as first grooves] forming in the process first peaks 112. Second grooves 124 are cut perpendicularly to the first grooves 114 forming in the process second [cross or intersecting] peaks 122.

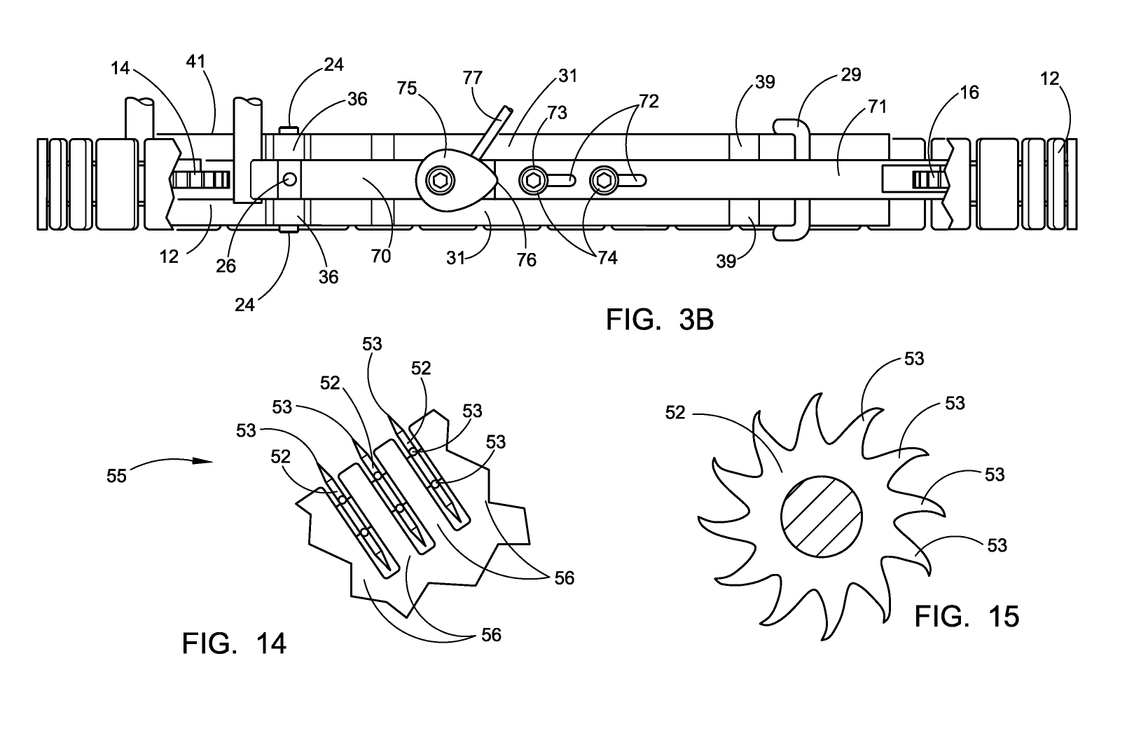

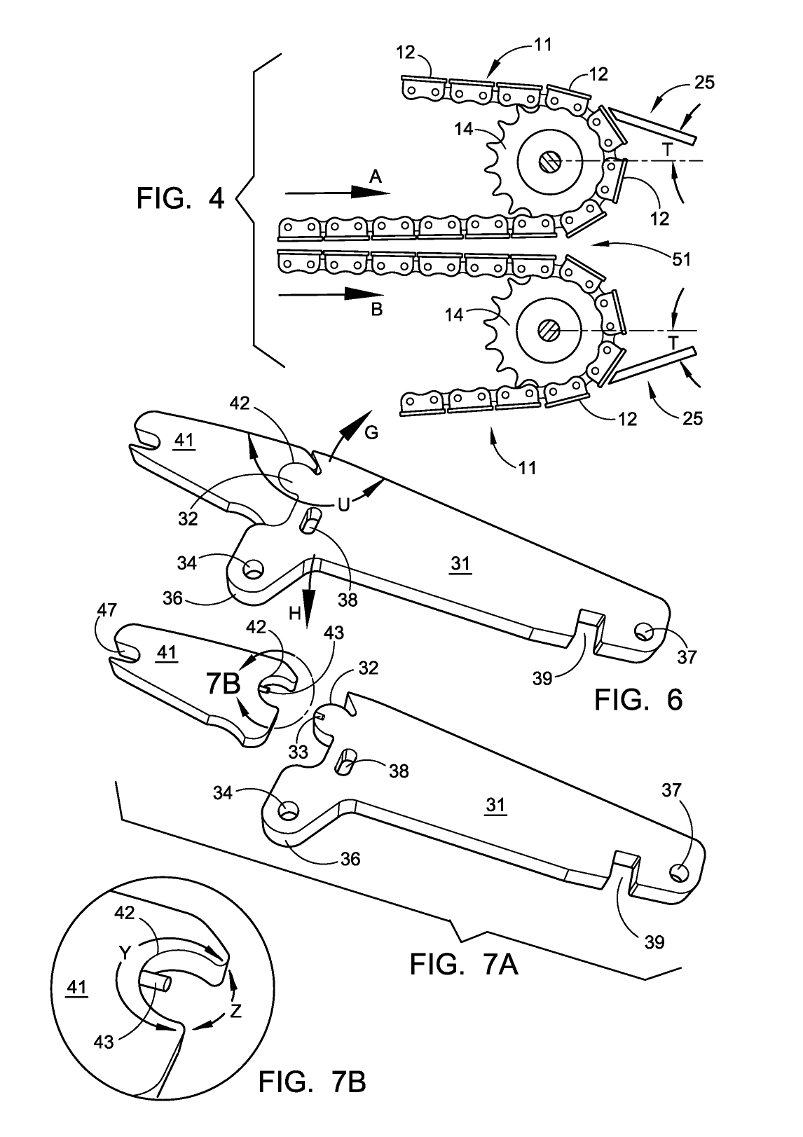

FIGS. 3A and 4, in conjunction with FIGS. 8 through 10, illustrate an additional feature of the avocado pulper 10; that of the scraping member 25 at the rear of each grip belt 11 which is in communication with each grip plate 12 as the grip plates rotate to scrap any residual skin 96 off from each grip plate 12 as they pass by. In addition to the grooves 114, 124 and peaks 112, 122 on each grip plate 12, one or more radial slots 15 are cut into the grip plates in a direction approximate to the direction of an avocado 95. Each radial slot 15 is a single arcing cut and two such radial slots 15 for each grip plate 12 are shown and preferred for optimum results.

The radial cuts 15 bear an arc approximately equal to the radius of the drive gear 14 and such is represented by arc-W. Each radial cut 15 is aligned with the scraping members 25 and to touchingly communicate therewith. Arc-W, being approximately equal to the radius of the drive gear 14, causes the scraping members to maintain a virtual constant communication with the radial cuts 15 as the grip plates 12 rotate and pass by. For maximum results, the scrapers 25 are angled at the apex of the drive gear 14 as referenced from its center and such angle is represented by Angle-T in FIG. 4, wherein Angle-T could range from 0° to approximately 45°, or more. Best results are obtained with Angle-T at approximately 10°.

FIG. 2 illustrates a two-piece conveyor belt 90A, 90B between which is a recessed channel 91. The width between the two pieces of conveyor belt 90A, 90B is slightly greater than an avocado seed but substantially less than the width of an avocado. The depth of the recessed channel 91 is greater than a depth of an avocado seed 98 while the avocado 95 rides on each conveyor belt 90A, 90B. The two-piece conveyor belt 90A, 90B is structured such that as the avocado is conveyed toward the opening 21 at the front of the grip belts 11, the seed 98 will not touch the bottom of the recessed channel 91. The recessed channel may be of any shape suited for the intended purpose, including but not limited to U-shaped [with radial contours] or V-shaped.

The typical separation between the belts 90A, 90B should ranges from approximately ¾ inch to approximately 2 inches and the typical depth of the recessed channel 91 should range from approximately ¼ inch to approximately 1 inch to thereby accommodate varying sized avocado seeds.

Reference should now be made to FIG. 3A to best illustrates the basic operations of the avocado pulper 10. As the avocado rides on the conveyor 90A, 90B it enters into the two rotating grip belts 11 at the front opening 21. As the belts converge at their approximate middle [reference character M] the avocado 95 is more fully grabbed. Slightly forward of the middle [Section-M] there is positioned a de-seeder 50 and slightly rearward of the de-seeder 50 is a seed divider 61. The de-seeder 50 comprises one or more rotating wheel-like structures 52 each having a plurality of protruding spikes or prongs 53 in a star-like or hook-like fashion. The wheel-like structure 52 rotates in a direction [Arrow-F] opposite to the direction of travel [Arrow-E] of the avocado 95.

The star-like nature of the prongs 53 project into the seed 98 and, by the respective movements of the wheel-like structure 52 and avocado 95, extract and eject the seed 98 from the avocado 95. The seed divider 61 prevents contamination or co-mingling of the extracted seed 98 with the pulp 97 which will be squeezed from the avocado 95 as it progresses rearward and is squeezed by the grip belts 11 in combination with the belt guides 30.

The wheel-like structure 52 of the de-seeder 50 are cleaned by a cooperating comb-like structure 55 having protruding fingers 56, as illustrated in FIG. 14, and are in touching communication with each wheel-like structure 52 to thereby scrape the wheel-like structures 52 and clear any seed 98 residue therefrom.

This squeezing more effectively occurs at a point rearward of the middle of the grip belts 11 and slightly rearward of the seed divider 61 and is designated as Section-S in FIG. 3A. The avocado 95 and its skin 96 rides generally fully within the grip belts 11 and at Section-S maximum inward biasing and, thereby, squeezing out the pulp 97 occurs. The pulp falls to a point rearward of the seed divider 61 and forward of a pulp divider 62. Squeezing pressure diminishes at a point rearward of Section-S wherein a slight separation between each grip belt 11 occurs which thereupon causes the skin 96 to be discarded. The scraping members 25 remove any residual skin 96 as previously described.

FIG. 4 also illustrates that the grip belts 11 are in virtual [near] contact with one another particular at the maximum squeezing section and then separate forming a rear opening 51. Typically, the opening 21 at the front can be at a ratio of approximately 8:3 in relation to the rear opening 51 with the maximum squeezing section [Section-S] at nearly “zero”.

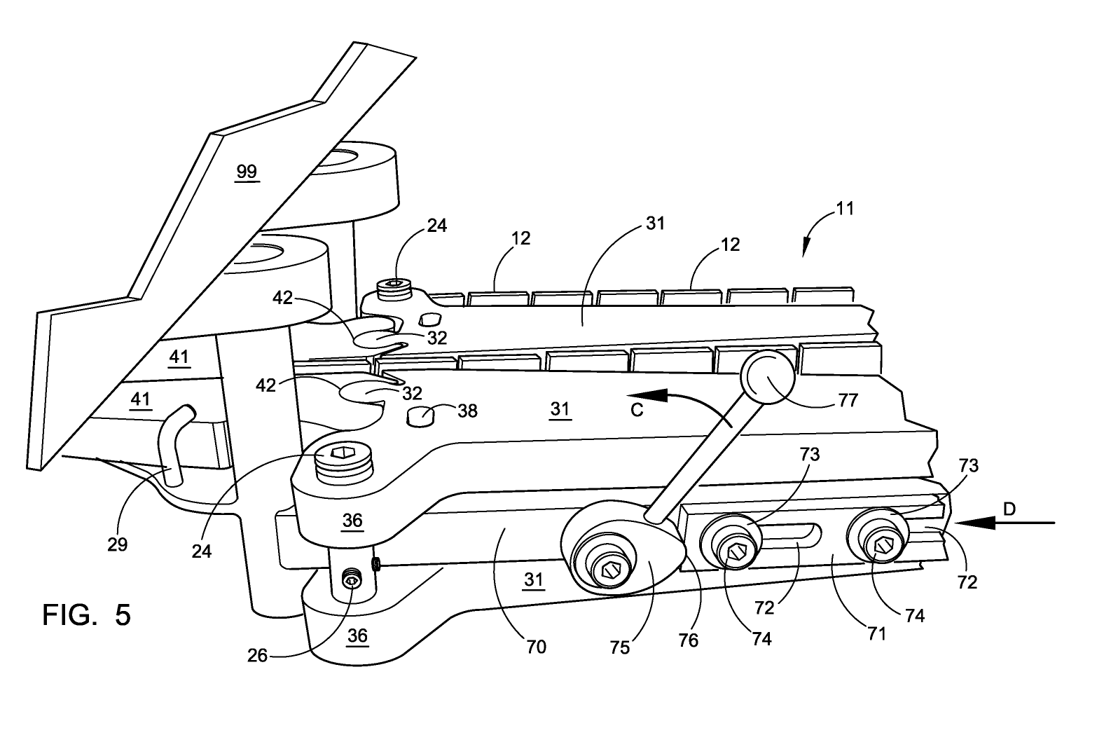

The two-piece belt guide 30 was discussed in detail above. The preferred embodiment of the avocado pulper 10 envisions a first belt guide 30 above the support plate 70 in the inner section of one grip belt 11 and a second belt guide 30, also above the support plate 70 in the inner section of the other grip belt 11 [best illustrated in FIG. 1] and a first bottom belt guide 30 below the support plate 70 and directly below the first belt guide 30 and a second bottom belt guide 30 below the support plate 70 and directly below the second guide plate 70 [as best illustrated in FIGS. 3B and 5.

As configured the respective belt guides 30 “sandwich” over the support plate 70 and pivot in tandem inward as the maximum squeeze point is reached and retract somewhat as the grip belts 11 pass the maximum squeeze point. Maximum squeezing pressure occurs at a point where each grip belt 11 passes the adjusting tab 36 of each front guide section 31 of the belt guide 30 and the bias member 80 exerts inward force on the opposing belt guides 30 and, consequently, on the avocado 95 in between the two opposing grip belts 11. The bias member 80 may be a commercially available expansion spring or a commercially available hydraulic of pneumatic device, each being suited for the intended purpose.

Maximum squeezing is facilitated by this inward biasing and a first rod 81 which is pivotably attached to the housing 99 and inserts through the elongated slot 38 of the first [top] front guide section 31 and first bottom front guide section 31 [left side belt guide 31 as seen from FIG. 1] and a second rod 82 which is pivotably attached to the housing 99 and inserts through the elongated slot 38 of the second [top] front guide section 31 and the second bottom front guide section 31 [right side belt guide 31 as seen from FIG. 1]. The first rod 81 is angled with regard to the second rod 82 and such angle is represented as Angle-X which ranges from 0° to approximately 15°. With this angling greater squeezing can be exerted on the grip belts 11 at their respective bottoms, by the respective bottom belt guides 30, where more of the pulp 97 generally is situated.

The inward biasing member 80 is attached to outward extending arms 83, 84 which are on the respective first rod 81 and second rod 82. The respective elongated slot 38 of each front guide section 31, through which the respective rods 81, 82 are inserted, permit each two-piece belt guide 30 to pivot in the direction of Arrow-G as greater inward biasing is realized and in the direction of Arrow-H as the avocado passes through the squeezing pressure section. This back and force, pressure movement, maximizes pulp 97 extraction from the avocado 95.

As illustrated in FIG. 6, front guide section 31 and rear guide section 41 are “at rest” and bear an angle with respect to one another characterized as Angle-U wherein Angle-U ranges from approximately 155° to approximately 179°. The “flexibility” of the belt guide set 30 permits easy passage and squeezing out of pulp for an avocado 95 which is “hard”, not as soft as is typically encountered for best pulp-removal results. In this regard, as the hard avocado passes through the middle [Section-M] of the grip belts 11 where maximum squeezing occurs, belt guide 30 [front guide section 31 and rear guide section 41] moves in the direction of Arrow-H causing Angle-U to become relatively linear [i.e., be at approximately 180° or more] to permit its passage. Generally approximately 165° to approximately 170° functions best for this purpose.

During operation, the avocado pulper 10 may require adjustment to ensure maximum squeezing pressure is exerted on the avocado 95 to maximize pulp 97 output and productivity as well as preventing the knurling [peaks 112, 122] of the guide plates 12 from prematurely wearing. In this regard, the adjusting screw 26 rests on support plate 70 and can be adjusted inward or outward against the support plate 70 to slightly separate the grip belts 11 from one other or to bring them closer together as needed to ensure maximum pulp 97 removal and minimal guide-plate 12 wear.

As best illustrated in FIGS. 1, 3B, and 5, the idler gear 16 is connected to an adjusting plate 71 which is translatably attached to the support plate 70. The idler gear 16 is at the front and receives and maintains the grip belt as it rotates. The adjusting plate 71 is translatable forward or backward, in the direction of Arrow-D as the adjustment lever 77 is moved in the direction of Arrow-C [i.e., with the avocado pulper 10 at full tension as illustrated in these figures, moving the adjustment lever 77 in the direction of Arrow-C causes the cam 75 with its protruding nub 76 to relieve the force it is exerting on the adjusting plate 71 and move the adjusting plate 71 in the direction of Arrow-D]. Movement in this direction, Arrow-D, not only relieves the tension on the grip belts 11 but also facilitates disassembly of the grip belts 11 and belt guides 30 from the avocado pulper 10 for maintenance, cleaning, repair, or replacement.

Adjusting plate 71 is slidingly attached to support plate 70 by a convention screw or bolt 74, such as but not limited to a shoulder bolt, which inserts through the horizontal slots 72 of the adjusting plate 71. A washer 73 maybe, but need not, be placed over the bolt 74 before it is inserted through the horizontal slots 72 and fastened to the support plate 70.

Ease of disassembly is facilitated by the receiving slot 47 at the rear of the rear guide section 41, the front retaining/swivel pin 22 which accepts the front receiving aperture 37 adjacent to the front of the front guide section 31, the cut-out 39 adjacent to the receiving aperture 37, and retaining pins 29. With the adjusting plate 71 in a non-tension mode [rearward], the front retaining pin 29 is approximately over the cut-out 39. In such a position, the belt guide 30 may easily be lifted upward past the retaining pin 29, and then forward at which point it has been removed from the support plate 70.

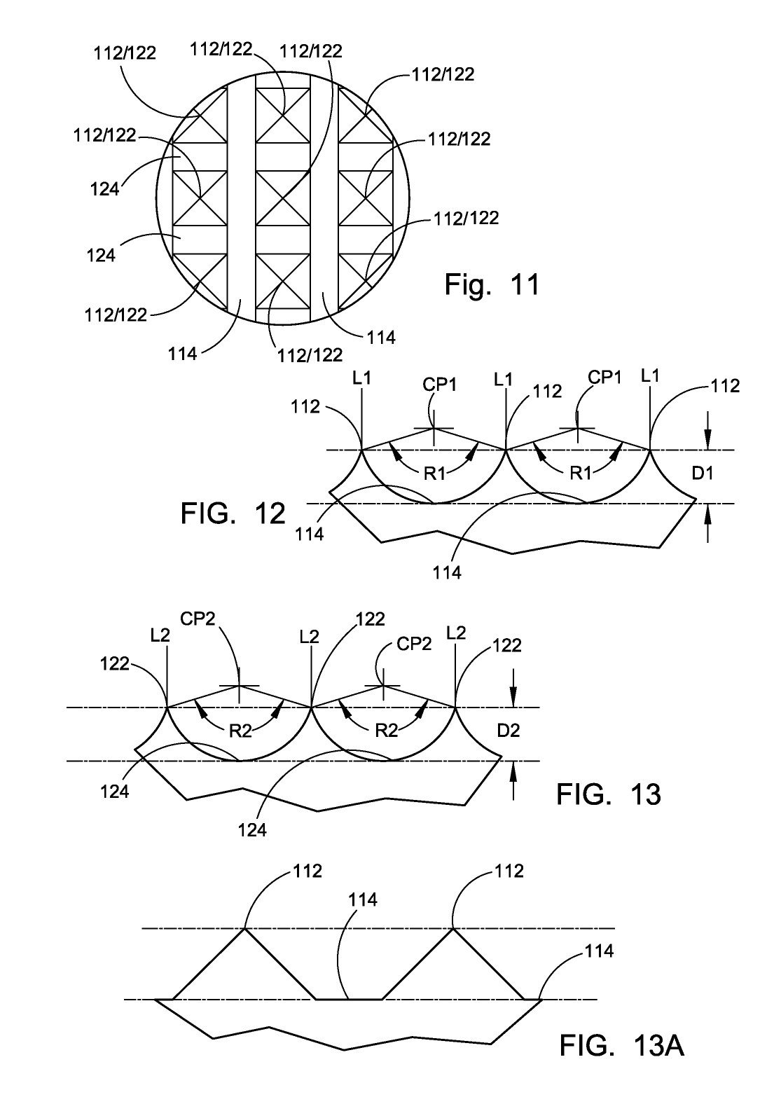

Referring to FIGS. 11 through 13 for greater detail on a grip plate 12 best suited for functionality, the first groove 114 of is illustrated as a radial groove [relatively curvilinear] and is represented by reference character R1 wherein R1 is a radial angle from its center point [CP1] from one first peak 112 to the next adjacent first peak 112. The depth of the first groove 114 is represented by reference character D1 [or Depth-D1].

In this embodiment, for good results, the radial angle for R1 should range from approximately 115° to approximately 130° and the depth [Depth-D1] should range from approximately 0.020-inches to approximately 0.080-inches. The distance from one first peak 112 to the next adjacent first peak 112 [referred to as length-L1] should ranges from approximately 0.060-inches to approximately 0.250-inches. Best results are achieved when the radial angle R1 is approximately 123°, the depth D1 is approximately 0.034 to 0.035-inches, and the distance from first peak 112 to the next adjacent first peak 112 [L1 to the next adjacent L1] is approximately 0.110-inches; or where the ratio between D1 to L1 is approximately 1:3.

The second grooves 124 [also illustrated to be radial grooves] is represented by reference character R2 wherein R2 is a radial angle from its center point [CP2] from one second peak 122 to the next adjacent second peak 122. The depth of the second groove 124 is represented by reference character D2 [or Depth-D2]. For good results, the radial angle for R2 should range from approximately 115° to approximately 130° and the depth [Depth-D2] should range from approximately 0.020-inches to approximately 0.080-inches but should generally be less than D1. The distance from one second peak 122 to the next adjacent second peak 122 [referred to as length-L2] should range from approximately 0.060-inches to approximately 0.250-inches. Best results are achieved when the radial angle R2 is approximately 123°, the depth D2 is approximately 0.033-inches [and less than D1], and the distance from second peak 122 to the next adjacent second peak 122 is approximately 0.110-inches; or where the ration between D2 to L2 is approximately 1:3.

The grooves 114, 124 as discussed above are radial but need not be but may be relatively straight-cuts [as illustrated in FIG. 13A] and may bear more than one angle and more than one cut, provided the peaks 112, 122, as the knurling. It should be noted that the shape of the groove/cut is not as important as the fact that the peaks [knurlings] are evident and prominent. It should also be noted that the respective depth of D1 [first groove 114], for more efficient scraping of residual pulp, should generally be deeper than D2 [second groove 124].

It also does not matter in manufacture which grooves [first 114 or second 124] are cut first, for discussion purposes if the first grooves 114 are cut first the first peaks 112 stand alone. Once the second grooves 124 are cut, the second peaks 122 and adjacent first peaks 112 should basically become one and the same peak and thereby share the same termination point.

The present disclosure includes that contained in the present claims as well as that of the foregoing description. Although this avocado pulper of this disclosure has been described in its preferred forms with a certain degree of particularity, it is understood that the present disclosure of the preferred forms has been made only by way of example and numerous changes in the details of construction and combination and arrangement of parts and method steps may be resorted to without departing from the spirit and scope of the avocado pulper of this disclosure. Accordingly, the scope of the avocado pulper of this disclosure should be determined not by the embodiment[s] illustrated, but by the appended claims and their legal equivalents.

Applicant has attempted to disclose all the embodiment[s] of the avocado pulper of this disclosure that could be reasonably foreseen. It must be understood, however, that there may be unforeseeable insubstantial modifications to avocado pulper of this disclosure that remain as equivalents and thereby falling within the scope of the avocado pulper of this disclosure.

What is claimed is:

1. An avocado pulper having a front and a rear, said avocado pulper comprising:
(a) conveying means for conveying an avocado through the avocado pulper;
(b) a first grip belt approximately oval in shape and thereby defining a front end, a back end, and an inner section, and having a plurality of grip plates therearound, said first grip belt being rotated in a first direction toward the rear of the avocado pulper;
(c) a second grip belt approximately oval in shape and thereby defining a front end, a back end, and an inner section, and having a plurality of grip plates therearound, said second grip belt being rotated in a second direction, opposite to said first direction, toward the rear of the avocado pulper wherein said first grip belt and said second grip belt are adjacent to one another and define an opening at their respective front ends and above said conveying means for receiving the avocado wherein said plurality of grip plates of said first grip belt and said second grip belt grip the avocado and pass the avocado toward the respective back ends of said first grip belt and said second grip belt and wherein said first grip belt and said second grip belt are in approximate contact with one another at their approximate middles and rearward therefrom;
(d) a support plate removably retaining said first grip belt and said second grip belt;
(e) means for squeezing pulp from the avocado and removing its skin as the avocado is passed toward the respective back ends of said first grip belt and said second grip belt wherein said means for squeezing pulp is removably attached to and within the inner section of each of said first grip belt and said second grip belt; and
(f) motor means for driving said first grip belt and said second grip in their respective said first direction and said second direction and wherein said motor means has a drive gear attached to said first grip belt and to said second grip belt.

2. The pulper of claim 1 wherein said means for squeezing pulp comprises a first belt guide on said support plate and within said inner section of said first grip belt and having a front guide section and a rear guide section pivotably attached to one another, a second belt guide on said support plate and within said inner section of said second grip belt and having a front guide section and a rear guide section pivotably attached to one another, and bias means on said support plate for biasing each respective belt guide inward toward each other with sufficient force to maintain said first grip belt and said second grip belt in approximate contact with one another at their approximate middles and rearward therefrom to thereby squeeze virtually all the pulp from the avocado.

3. The avocado pulper of claim 2 wherein said means for squeezing pulp comprises a first bottom belt guide on and below said support plate and connected to said first belt guide, said first bottom belt guide having a front guide section and a rear guide section pivotably attached to one another, and a second bottom belt guide on and below said support plate and connected to said second belt guide, said second bottom belt guide having a front guide section and a rear guide section pivotably attached to one another.

4. The avocado pulper of claim 3 further comprising adjustment means for adjusting lateral distances for said first belt guide in tandem with said first bottom belt guide from or toward said support plate and for adjusting lateral distances for said second belt guide in tandem with said second bottom belt guide from or toward said support plate.

5. The avocado pulper of claim 4 wherein said front guide section of said first belt guide, of said second belt guide, of said first bottom belt guide, and of said second bottom belt guide further comprises a retaining aperture through which said adjustment means inserts.

6. The avocado pulper of claim 2 wherein said front guide section of said first belt guide, of said second belt guide, of said first bottom belt guide, and of said second bottom belt guide comprises a rounded head extension at their respective rears with a receiving aperture therein and wherein said rear guide section of said first belt guide, of said second belt guide, of said first bottom belt guide, and of said second bottom belt guide comprises a connection aperture at their respective fronts with an index pin protruding from therein wherein each said rounded head extension is adapted to snap into each said adjacent receiving aperture and each said index pin mates with each said adjacent connection aperture to thereby form a secured pivotable belt guide.

7. The avocado pulper of claim 6 wherein each said receiving aperture has an arc of opening ranging from approximately 150° to about 175° to thereby securely and pivotably mate with each said rounded head.

8. The avocado pulper of claim 2 wherein said bias means comprises a first rod, a second rod, and an inward biasing member connected to said first rod and to said second rod, wherein said first rod projects approximately to said support plate from above and through an elongated slot in said front guide section of said first belt guide, and said second rod projects approximately to said support plate and through an elongated slot in said front guide section of said second belt guide.

9. The avocado pulper of claim 8 wherein said inward biasing member is selected from the group consisting of expansion spring, hydraulic pistons, and pneumatic pistons.

10. The avocado pulper of claim 1 further comprising tension means relieving tension of said first grip belt and said second grip belt to thereby facilitate removal of said first grip belt and said second grip belt from the pulper.

11. The avocado pulper of claim 1 wherein said conveyer means comprises a first section conveyor belt, a second section conveyor belt adjacent to said first section conveyor belt, and a recessed channel between said first section conveyor belt and said second section conveyor belt which is sized to have a width slighter greater than a width of an avocado seed and to have a depth such that the pulp of the avocado rides on said first section conveyor belt and on said second section conveyor belt and the seed does not touch bottom of said recessed channel.

12. The avocado pulper of claim 11 wherein said recessed channel is approximately U-shaped or V-shaped.

13. The avocado pulper of claim 1 further comprising de-seeder means from removing a seed from the avocado before the pulp of the avocado is removed from its skin.

14. The avocado pulper of claim 13 wherein said de-seeder means comprises a plurality of rounded structures adjacent to a terminus of said conveyor means, said plurality of rounded structures rotating in a direction opposite a direction of travel of said conveyor means and having a plurality of extending prongs for gripping the seed and extracting the seed from the avocado.

15. The avocado pulper of claim 14 wherein said plurality of extending prongs are star-like or hook-like members.

16. The avocado pulper of claim 14 wherein said de-seeder means further comprises scrapers adjacent to each side of said plurality of rounded structures for scraping residual pulp from the seed.

17. The avocado pulper of claim 1 further comprising a seed divider for retaining seed removed from the avocado.

18. The avocado pulper of claim 1 further comprising a pulp divider for retaining the pulp removed from the avocado.

19. The avocado pulper of claim 1 wherein each grip plate of said plurality of grip plates of said first grip belt and of said second belt has surfaces which are knurled.

20. The avocado pulper of claim 1 wherein each grip plate of said plurality of grip plates has at least one cut on opposing ends wherein each cut of said at least one cut is horizontally disposed.

21. The avocado pulper of claim 20 wherein said cut on each of said plurality of grip plates is a radial cut which bears a radius approximately equal to a radius of said drive gear.

22. The avocado pulper of claim 20 further comprising a scraping member adjacent to the back end of said first grip belt and to the back of said second grip belt wherein said scraping member is in touching communication with each cut of each said grip plates as said first grip belt and said second grip rotate.

23. The avocado pulper of claim 1 wherein each grip plate of said plurality of grip plates of said first grip belt and of said second belt has a plurality of first grooves with a depth-D1 and corresponding first peaks having a length-L1 from one first peak to an adjacent first and further having a plurality of second grooves with a depth-D2 and corresponding second peaks having a length-L2 from one second peak to an adjacent second peak wherein said plurality of second grooves are approximately perpendicular to said plurality of first grooves.

24. The avocado pulper of claim 23 wherein depth-D1 bears a ratio to length-L1 of approximately 1:3.

25. The avocado pulper of claim 23 wherein said depth-D1 is greater than said depth-D2 and said length-L1 is approximately equal to said length-L2.

26. The avocado pulper of claim 23 wherein said depth-D1 and said depth-D2 range from approximately 0.020 inches deep to approximately 0.080 inches deep.

27. The avocado pulper of claim 23 wherein said depth-D1 is approximately 0.034 inches deep to approximately 0.035 inches deep and said depth-D2 is approximately 0.033 inches deep.

28. The avocado pulper of claim 23 wherein each one of said first peaks and each adjacent one of said second peaks of said first drum and said second drum share a termination point.

29. The avocado pulper of claim 23 wherein said length-L1 and said length-L2 ranges from approximately 0.060 inches to approximately 0.250 inches.

30. The avocado pulper of claim 23 wherein said length-L1 and said length-L2 each are approximately 0.110 inches.

31. A belt guide for use on an avocado pulper comprising:
(a) a front guide section having a rounded head extension at its rear with a receiving aperture therein;
(b) a rear guide section pivotably attached to said front guide section having a connection aperture at its front with an index pin protruding from therein wherein said rounded head extension is adapted to snap into said receiving aperture and said index pin mates with said connection aperture to thereby form a secured pivotable belt guide.

32. The avocado pulper of claim 31 wherein said receiving aperture has an arc of opening ranging from approximately 150° to about 175° to thereby securely and pivotably mate with said rounded head.
